(19) United States
(12) Patent Application Publication
(10) Pub. No.: US 2006/0263560 A1
(43) Pub. Date: Nov. 23, 2006

(54) Pressure sensitive web intermediate assembly having discrete preprinted surface elements disposed on a continuous web of material

(76) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(21) Appl. No.: 11/151,484

(22) Filed: Jun. 13, 2005

Related U.S. Application Data
(63) Continuation-in-part of application No. 11/135,481, filed on May 23, 2005.
(63) Continuation-in-part of application No. 11/135,179, filed on May 23, 2005.
(63) Continuation-in-part of application No. 11/135,131, filed on May 23, 2005.

(51) Int. Cl. B32B 33/00

(52) U.S. Cl. 428/40.1; 428/42.3

(57) ABSTRACT

The present invention relates to a composite intermediate web assembly that is produced by using a substrate having plastic or synthetic properties and includes the application of a number of individual segments that are placed on the surface of the web in for example, an edge-to-edge configuration. A series of preprinted, discrete sheet segments are individually and sequentially placed and then laminated to the web by the use of a pattern of adhesive. A placer mechanism positions each of the segments on the web in a pre-determined pattern. Each of the segments is preprinted with high quality imaging prior to application of the segments to the web of material. The segments remain free of attachment to one another after application to the web. The resulting intermediate assembly can be further processed such as by die cutting to produce individual promotional or communication items including cards, signs, plates and placards.

### CROSS-REFERENCES TO RELATED APPLICATIONS

This application is a continuation-in-part of application Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference.

### FIELD OF THE INVENTION

The present invention is in the field of composite, intermediate manufacturing systems and methods that are used in the preparation of articles, such as pressure sensitive laminates. Such laminated assemblies may be used in the production of plastic cards, license plates, signs, placards and the like. More specifically, the present invention is in the field of business and marketing communications that are produced in a unique and continuous process. The instant specification includes providing a continuous web of a synthetic material, such as polyethylene, polypropylene, polystyrene and the like, and then applying a number of discrete, previously prepared and pre-printed segments over the top of the web to create an intermediate assembly that may be further processed, such as by die cutting, to produce synthetic or plastic like communications that can be used to convey information or aid in developing or advancing a promotion.

The segments, which represent an area of printable stock material, are produced in part, initially from a pre-imaged or pre-printed sheet that is then cut, converted or merged to a roll type of format through use of a placer mechanism that sequentially places the cut pieces on the web to create a partially laminated assembly.

The sheets are preferably printed with high quality graphics or images which are then slit or cut to size (regular and irregular shapes) to form templates, ribbons, surface elements or segments for the particular application. The segments are then converted to or merged with a continuously advancing web to create a continuous, laminate roll format. The segments that have been affixed to the web are provided in one or more intermediate laminated configurations to an end user. By using the process of the present invention high quality graphics can be prepared to further enhance the particular offering that is being created. More particularly, the pressure sensitive intermediate of the instant application can be used to create individual, plastic articles including novelties having a high or photo quality resolution level such as those about 300 lines per inch or approximately 2500 to 3500 dots per inch.

### BACKGROUND OF THE INVENTION

Cards, license plates, signage, placards and the like have become increasingly common in the business forms and labels industry to promote business communications. Today's growth of new technology plays a vital role in creating and providing businesses forms, which can be used in a variety of businesses and industries. For example, plastic cards may be used in a number of applications, such as for advertising and marketing, membership and participation, coupon redemption, message memos, emergency numbers, business and service references, photographs, rebates, etc.

Card products today are commonly assembled by applying one or more covering films to the surface of a web to create a laminated assembly. The web of material may be printed or imaged with card related indicia or alternatively a sheet of material may be affixed to the web and then an over laminate is applied. The laminated assembly is then die cut to produce a number of separate cards.

The imaging or printing that is applied to the web or sheet of material is typically produced using a number of conventional processes. For example, a web of material can be processed through a flexographic press. Then the web, which serves as the primary web of material is covered with one or more films to create a laminated assembly. Alternatively, sheet feed ink jetting equipment may be used to create sheets that are then included in the process of card manufacturing.

Flexography is commonly used today for the printing of decorative items including the rendering of packaging, printing of web material. Normally, the process employs a series of plates and one or more stations, containing inks that are used to apply colored images to the web as the web traverses the press. Through improvements in ink qualities and other modifications and enhancements in the technology, the image quality in flexographic presses and resulting products has improved to about 150 lines per inch.

Typically, and serving as a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms, in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time that is involved in preparing a production job to run or “make ready” as it may otherwise be known in the industry. That is, the steps that are used to prepare the flexography equipment for running a particular job or order. This “make ready” process includes such activity as the preparation of multiple plates to produce the image at each station, mixing inks, calibration and alignment of the images between stations and the like. Operation of the flexography presses may also include multiple operators, which can add to manufacturing costs. In addition, waste can be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready process and waste factors, the production of products (e.g. prime labels) through the use of flexography may then be limited to serving only certain market segments, namely large market segments. Markets that are applicable for this technology segment are generally believed to be those orders for large quantities such as those exceeding several hundred thousand or millions of pieces, which potentially leaves the smaller label market, e.g. 100 up to 1,000,000 labels, unfulfilled or at least not adequately served by currently available technologies due to cost and materials thresholds.

Another drawback believed to be associated with flexographic technologies is that the technology cannot provide any variability in the product, including such basic functionality as sequential numbering, addressing or adding promotional text in connection with a seasonal advertisement or other offering without the addition of further processing stations. If such features are required by an end user or customer, such as with product date or coding, this function generally cannot be performed by flexographic presses without the inclusion of additional stations. Instead, these features typically must be achieved through an off line operation, such as ink jetting, often after the label has been applied to the container or carton. Alternatively, the ink jetting may be performed directly on the container as part of a separate operation.

Flexographic presses normally have a number of pre-determined stations. For example, a four color press may have only four stations that can be used to treat or process the web. Thus, if other stations are to be added, such as a numbering head, the manufacturer likely then has to reduce the number of colors that can be added to the web as one station has been surrendered for the numbering head.

Flexographic technology also limits the ability to add personalization to products produced on such presses. This may be particularly desirable in certain market segments where such prime label products on consumer package goods (“CPG”) may further enhance the product or service offering by making the product more attractive to prospective purchasers, thereby increasing the appeal to the consumer of the product or service.

Identifiers such as labels, business cards or tags may also be readily rendered using desktop equipment. While the resolution may be slightly improved when compared with conventional flexographic technology, speeds of application are significantly reduced as the images are processed in a sheet wise fashion on desktop equipment. This results in only a few sheets per minute being produced as opposed to hundreds of feet per minute that are commonly capable of being processed by flexographic equipment. That is, the desktop unit may only handle and print one sheet at a time before the next sheet is advanced for printing or imaging when compared with a conventional web fed process which produces sheets at a faster rate. Thus, in using such a desktop process, one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed, therefore, is an intermediate pressure sensitive assembly that can be created on which high quality graphics can be used to produce card products, plastic signage, placards and the like for a number of distinct applications and with a high degree of variability. For example, graphics having a resolution in excess of about 150 lines per inch can be produced in an efficient and cost effective manner, such as in a system handling a continuous web of material operating at greater than fifty feet per minute to which discrete segments can be applied. Moreover, a system which can add substantial variability to the product as well as other features, such as embossments, over laminates, variable printing or imaging and the like, would greatly expand the penetration of this form of business communication in the marketplace. The present invention seeks to provide an intermediate assembly that is capable of having a number of different surface configurations, with the possible addition of ancillary elements such as labels, cards, tags, plastics, films and the like. The surface configurations, which will consist of a series of discrete individual elements, will each have printing or imaging that includes graphical or resolution quality of about 150 or more lines per inch and preferably more than 300 lines per inch, which is approximately equal to about 2500 to 3500 dots per inch (“DPI”) in order to create a high quality image product that is intended to be aesthetically appealing to the consumer and to more effectively communicate the business message of the application.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process or system by which a manufacturer can create high quality printed form product templates, in a continuous process with each of the templates, segments or ribbons having significantly improved graphic resolution that is greater than about 150 lines per inch, preferably greater than about 200 lines per inch and still more preferably about 300 lines per inch, in an efficient and cost effective manner. Through the development of the present process and the creation of the unique intermediate web assembly described in this invention, the manufacturer can now service a particular niche market segment for creating high quality segments, ribbons or templates in a continuous fashion, such as those ranging from approximately 100 to 1,000,000 pieces. While the foregoing market size or segment is a target area of the present invention, it should be appreciated that the invention may be practiced and used to fulfill larger order quantities, such as those of one million or more.

The pressure sensitive intermediate of the present invention is created through a unique sheet to roll process which provides savings specifically through reduced make ready time and generation of waste material and yields a higher image resolution product when compared with conventional processes such as those produced by using conventional flexographic technologies.

The present invention uses previously prepared sheets, with each sheet having a number of individual, discrete segments that have imaging or printing, e.g. graphical depictions, already applied to the sheets in the area of the segments before the segments are provided to the manufacturing press. The printing is provided in pre-defined areas, determined prior to production, to create individual segments that can be used for a number of purposes. The templates or segments are then cut from the sheet and supplied to a feeder mechanism.

The templates, sheets, ribbons or segments are then individually and sequentially applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is not limited in functionality as a number of materials, operations and options may be used in creating a relatively dynamic product. Such additional processes may include variable printing, embossments, coatings, over laminates and the like.

By preparing the intermediate laminate assembly in the manner described herein, the intermediate web can be processed continuously at speeds of greater than 50 feet per minute, preferably between 75-150 feet per minute and still more preferably at speeds of about 200 feet per minute or greater.

In one exemplary embodiment, a pressure sensitive intermediate web assembly, is presented and includes a continuous plastic web substrate that has first and second surfaces, first and second longitudinally extending sides and a pattern of adhesive applied to the first surface between the first and second longitudinally extending sides.

The present embodiment includes a plurality of printable sheets with each sheet having a first length and width. Each of the sheets is cut into a plurality of individual segments, with each of the segments having a length and width that is less than the length and width of each of the sheets. Each segment has first and second faces, first and second longitudinally extending sides and first and second transversely extending edges. The segments are each provided with printing that is applied to at least a portion of one face prior to the segment being cut from the sheet.

Each of the segments is individually and sequentially applied to the continuous plastic web between the first and second longitudinally extending sides and substantially in an edge-to-edge configuration. The assembly that is created is a continuous intermediate configuration that has a series of discrete preprinted segments applied to the surface of the plastic web.

In a further embodiment of the present invention, a card intermediate assembly, is described and includes a plastic web of material that has first and second faces, first and second transversely extending edges and first and second longitudinally extending sides. The web has a substantially quadrate configuration.

A pattern of adhesive is applied to the first face of the plastic web between the longitudinally extending sides and said transversely extending edges. The adhesive will preferably be a permanent type pressure sensitive adhesive, although other adhesive types, such as removable and repositionable are, of course, suitable for use with this invention.

A sheet that has a length and width and which is divisible into a number of discrete individual segments is prepared by printing in the area of each of the segments. Each of the segments is smaller than the sheet. At least one of the segments, which has been previously cut from the sheet is applied to the plastic web over the pattern of adhesive. The segment is entirely contained between the longitudinally extending sides and the transversely extending edges to form a plastic card intermediate assembly.

In a yet still further embodiment of the present invention, a laminated, plastic web assembly is produced in accordance with the following method that includes the steps of initially providing a continuous web of plastic material. The web has first and second faces and first and second longitudinally extending sides. Then a pattern of adhesive is applied to the first face of the web between the first and second longitudinally extending sides. At least one sheet of material is preprinted with indicia, preferably high quality graphical depictions having a resolution greater than about 150 lines per inch. Next, the sheet of material is then cut into a number of discrete individual segments that are smaller than the size of the sheet, with each of the segments containing printing. The segments are then applied sequentially to the continuous web of plastic material and over the pattern of pressure sensitive adhesive to create a continuous web having intermittently laminated preprinted segments applied thereto. A synthetic film is then applied over each of the segments to create a laminated intermediate.

The assembly or construction that is prepared in connection with the foregoing embodiments may be covered with one or more synthetic films that are preferably provided on each side of the web. However, only one film may be provided to cover the upper or top surface of the assembly after the segment or sheet has been applied to the web and affixed to the surface by the adhesive.

The assembly of the present invention can be die cut into any number of shapes or configurations and may also have supplemental elements added thereto, such as labels, coins, tokens, chips and combinations thereof. In addition, the assembly can be provided with variable printing such as may be necessary in the preparation of membership or participation cards and the like.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross sectional view of the pressure sensitive laminate assembly prepared in connection with the present invention;

FIG. 2 shows a top view of the pressure sensitive laminate assembly prepared in connection with the present invention;

FIG. 3 provides a representation of an exemplary pre-printed sheet showing the areas that will become the individual segments, once the segments are cut from the sheet of material;

FIG. 3A presents several individual segments that have been cut from the sheet shown in FIG. 3; and

FIG. 4 illustrates a block diagram presenting an exemplary method of practicing the present invention to produce a pressure sensitive laminated web assembly.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been discovered that there is no readily available intermediate assembly process or system by which a manufacturer can create high quality printed form product templates in a continuous process with each of the templates or ribbons each having significantly improved graphic resolution that is greater than about 150 lines per inch, preferably greater than about 200 lines per inch and still more preferably about 300 lines per inch, in an efficient and cost effective manner. Through the development of the present system and the creation of the unique intermediate web assembly described in this invention, the manufacturer can now service a particular niche market segment for creating high quality templates in a continuous fashion, such as those ranging from approximately 100 to 1,000,000. While the foregoing market size or segment is a target area of the present invention, it should be appreciated that the invention may be practiced and used to fulfill larger order quantities, such as those of one million or more.

The pressure sensitive intermediate of the present invention is created through a unique sheet to roll process which provides savings when compared with conventional processes such as flexography, specifically through reduced make ready time and generation of waste material and yields a higher image resolution product.

The present invention uses previously prepared individually created sheets, or segments, that have imaging or printing already applied to the sheets, e.g. graphical depictions, before the sheets are provided to the manufacturing press. The printing is provided in pre-defined areas, determined prior to production, to create individual segments that can be used for a number of purposes. The templates or segments are then cut from the sheet and supplied to a feeder mechanism. The templates, sheets, ribbons or segments are then applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is also not limited in functionality as a number of materials, operations and options may be used in creating a relatively dynamic product. Such additional processes may include variable printing, embossments, coatings, over laminates and the like.

By preparing the intermediate assembly in the manner described herein, the intermediate web can be processed continuously at speeds of greater than 50 feet per minute, preferably between 75-150 feet per minute and still more preferably at speeds of about 200 feet per minute or greater.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern, as defined herein, also is used in connection with the adhesive that is applied to the continuous web.

As used herein the term “business communication piece or document” refers to a substrate that, either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate, which is generally variable or unique and which may change from document to document or segment to segment, so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturer or supplier wishes to convey to an end user or customer of the offering.

The term “intermediate” as used herein, refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product, such as with the present invention, is provided in an intermediate condition so that a user can add or manipulate the intermediate to create the final or desired end product, such as applying the prime label to a container, carton or the like. Thus, in accordance with the present invention, the intermediate segment, for example, could be subject to die cutting or additional printing, such as through ink jetting, over laminating, coating or embossment, and then applied to a container, carton, consumer package good or the like.

The term “sheets” or “segments” as used herein, refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25″ sheet may be produced with five rows of labels, with each row having six labels, with each label having dimensions of approximately 3″×4″. For instance, in this example, each row may comprise an individual segment or sheet that may be used in practicing the present invention. It should, however, be understood that the invention is not to be so limited to the foregoing configuration that individual pieces or elements, regardless whether the piece or elements have a regular or irregular shape, may be used in connection with this process to produce the intermediate assembly that is described in this application.

As used herein, the term “templates” or “element” refers to a particular size, configuration or arrangement of a piece. For example, if the template or segment is a label, the label may have a size of 2″×4″, 1″×2″ and other sizes that may be customarily produced. Likewise, if the piece is a card, the card may have a size ranging from 3″×5″, 2″×4″ or any other suitably sized card. The term templates can be used to refer to segments, ribbons and similar terms.

Through use of the present invention, a vast array of identifiers, e.g. labels, tags, cards, plates, magnets, etc. can be placed on an adhesive coated web and then collected for later use, thereby creating a versatile pressure sensitive intermediate web assembly. Through the use of the unique process presented herein, a manufacturer may create innumerable high quality graphics, illustrations and variable and personalized text and indicia to create a greater impact on the potential consumer or end user. The invention provides a number of unique benefits when compared with conventional technologies in that the process can occur at roughly equivalent press speeds and may be handled by conventional applicators.

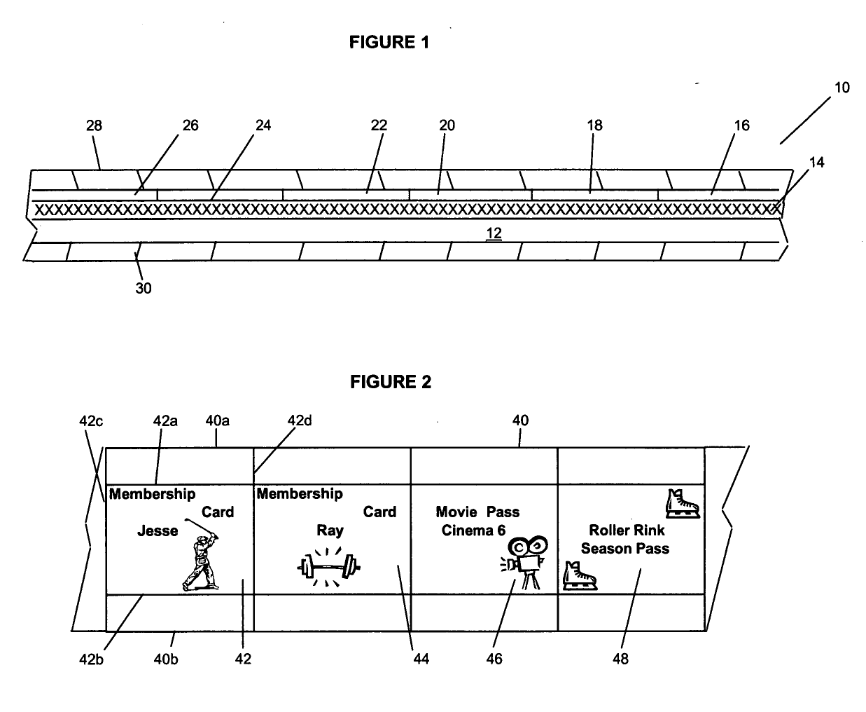

Reference is directed to FIG. 1 of the presently described embodiment. The pressure sensitive laminate assembly is generally depicted by reference to numeral 10. The assembly 10 preferably includes a continuous web 12 that is selected from a group including polyethylene, polypropylene, polystyrene and combinations thereof. While in the preferred embodiment, the web of material is provided in a continuous format, it should be understood that the web may be presented in a sheet configuration. The web will have a thickness ranging from about 0.005 mils to about 25 mils, depending on the application that is being manufactured. For example, a membership card will generally have a thickness less than a sign or placard. The width of the web will likewise be dependent on the particular application or job that is being manufactured.

The web 12 will have first and second faces, and first and second longitudinally extending sides. The web 12 will also have first and second transversely extending ends which will naturally occur at the beginning and end of the roll of material. If the web is provided in a sheet configuration, then obviously, the ends will appear at the ends or edges of the sheet of material.

A pattern of adhesive 14 is applied over the top of the web of material 12 and preferably will be a permanent adhesive so that when the individual segments are applied, the segments will be permanently affixed to the surface of the web. Other adhesives are of course useable in connection with the practice of the present invention, including removable, repositionable and heat seal type adhesives.

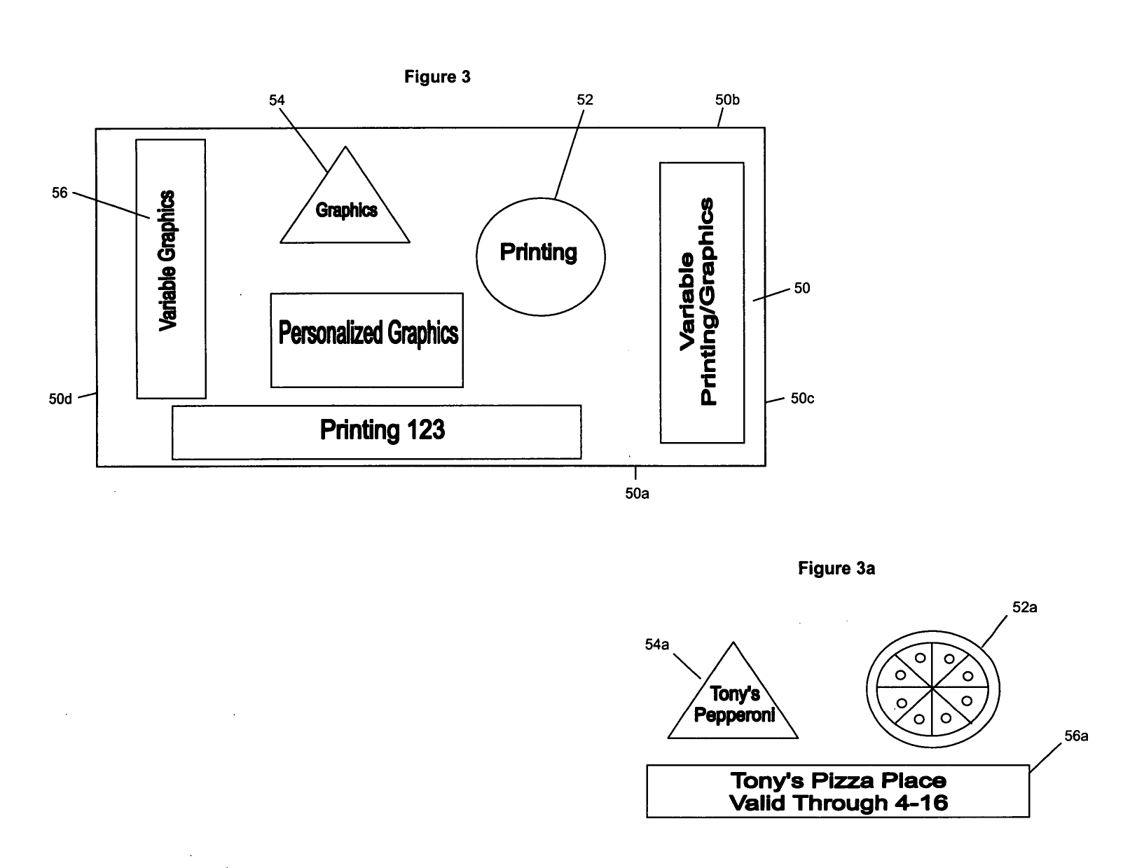

A series of discrete, individual segments or ribbons 16, 18, 20, 22, 24 and 26 are applied over the top of the adhesive. The segments will each have first and second longitudinally extending sides, first and second transversely extending edges and top and bottom faces. The segments are cut from a sheet (see FIG. 3) which is preprinted with graphics, indicia or combinations thereof in the area that will become the segments.

FIG. 1 is also used to indicate the application of a synthetic film 28 and 30 that has been applied over the top and bottom of the assembly 10 after the segments have been applied to the web 12. The films are intended to provide additional protection and complete the final lamination of the assembly when they are used.

Turning now to FIG. 2, the continuous web assembly is depicted by reference numeral 40 and shows a number of preprinted and variably imaged card segments 42, 44, 46 and 48 applied to the surface of the web. As can be seen from the drawing, longitudinally extending sides 42a and 42b of label segment 42 are disposed inwardly of longitudinally extending sides 40a and 40b of the web assembly 40. It should however be understood that the sides of the segments may be parallel with the sides of the web depending on the processing needs of the application or job being produced. The transversely extending edges of segment 42 are also represented by numerals 42c and 42d.

FIG. 3 provides an exemplary representation of a sheet of material 50 that is used in the preparation of the individual segments. Sheet 50 is preferably selected from any suitable printable sheet material and may include cellulosic based stock, films, foils, synthetic materials and the like. The sheet has first and second longitudinally extending sides 50a and 50b and first and second transversely extending ends 50c and 50d. The sheet of material will preferably be selected from a standard stock of material so that it may readily be processed by a high quality imaging device such as an Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

The sheet depicted in FIG. 3 will be preferably printed in a number of pre-determined discrete, individual areas represented by numerals 52, 54 and 56. As can be seen, the segments represented in the drawing have regular and irregular shapes and the invention is not limited by the type or shape of segment that can be printed and then cut from the sheet. Shapes, such as geometric, animate and inanimate may be prepared and utilized in the practice of the present invention. The areas 52, 54 and 56 that will make up the segments that are to be applied to the web are pre-printed with text and graphical depictions which may include variable and/or personalized printing, static or fixed informational printing and combinations thereof. In addition, the graphics and textual depictions may vary from one segment area to the next or be the same throughout the entire sheet or any sort of combinations thereof.

As can be seen from the drawing FIG. 3, each of the segments has a dimension (length and width) that is smaller than the dimension (length and width) of the sheet from which they are cut. In this manner, a number of segments may be printed while in the sheet configuration, thereby reducing the amount of waste material that needs to be trimmed away from the segments after cutting.

FIG. 3A shows a number of the segments after they have been cut from the sheet depicted in FIG. 3. Segments 52a, 54a and 56a are each presented with printing and graphics. The segments are further shown in a relational theme (in the present example, reference to a pizza establishment) to one another representing the diversity of print jobs and elements that can be created through practice of the present invention.

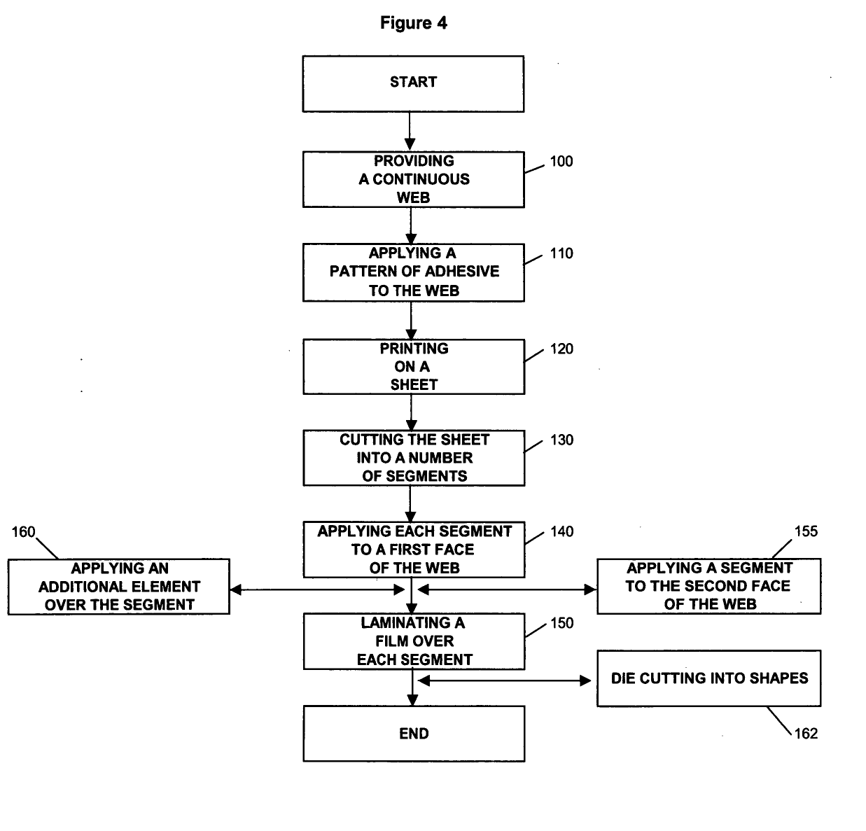

Attention is directed now to FIG. 4 of the presently described embodiment of the present invention. A block diagram is provided illustrating an exemplary method of constructing a pressure sensitive web assembly in accordance with the present invention. The process is started by advancing a continuous web of web material at step 100. Next, a pattern of adhesive is applied to the first or upper face of the web of material at step 110. As mentioned previously, the adhesive will preferably be a permanent pressure sensitive adhesive.

A series of sheets are provided and each sheet is printed at step 120. The printing is preferably performed using a high quality imaging device capable of generating photo quality images on the sheet of stock material. The sheet is then cut at step 130 by die cutting or other means, including laser die cutting and other mechanical cutting apparatus, to produce a series of discrete segments or ribbons, with each segment or ribbon having printing previously applied.

The segments are then placed into a placer mechanism, such as sold under the name Maverick® that is available from In-Line Automation of Minneapolis, Minn. and then are individually and sequentially applied to the web of material at step 140. The segments are preferably applied over the adhesive and to the first face of the web of material. However, in one exemplary alternate step, a second segment may be placed on the web on the second face opposite the first segment on the first face at step 155. In this arrangement, two preprinted segments are placed on opposite sides from one another to produce an intermediate assembly having preprinted segments on each side. A second pattern of adhesive may be applied in order to have the second segment adhere to the web. Alternatively, the segments may have an activatable adhesive applied to one side and the adhesive is activated such as by heat in order to permanently affix the segment to the web.

Next, a laminating film is applied over the top of the segment at step 150. In the event that the segments have been applied to both sides of the web of material, a second laminating film may be applied to cover and protect the second printed segment.

One further exemplary processing step may include the application of a coating or placing of additional elements onto one or more segments that may be accomplished at step 160. Such additional or supplemental elements include labels, chips, tags and combinations thereof. The web with the segments applied thereto may then be die cut at step 162 such as by using laser die cutting equipment or conventional die cutters.

It will thus be seen according to the present invention a highly advantageous pressure sensitive intermediate assembly has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A pressure sensitive intermediate web assembly, comprising;
a continuous plastic web substrate having first and second surfaces, first and second longitudinally extending sides and a pattern of adhesive applied to said first surface between said first and second longitudinally extending sides;
a plurality of printable sheets having a first length and width, each of said sheets is cut into a plurality of individual segments, with each segment having a length and width that is less than said length and width of each of said sheets;
each segment has first and second faces, first and second longitudinally extending sides and first and second transversely extending edges, and each of said segments has printing applied to at least a portion of one face prior to said segment being cut from said sheet; and
wherein each of said segments is individually and sequentially applied to said continuous plastic web between said first and second longitudinally extending sides and substantially in an edge-to-edge configuration so as to create a continuous intermediate assembly having a series of discrete preprinted segments applied thereto.

2. A pressure sensitive intermediate web assembly as recited in claim 1, including a first synthetic film that is applied over said segments, once said segments are applied to said web.

3. A pressure sensitive intermediate web assembly as recited in claim 2, including a second synthetic film that is applied to said second surface of said continuous web opposite said first synthetic film.

4. A pressure sensitive intermediate web assembly as recited in claim 1, wherein each of said segments is preprinted with personalized and variable indicia prior to application to said continuous plastic web.

5. A pressure sensitive intermediate web assembly as recited in claim 4, wherein said personalized and variable indicia is distinct on successive segments applied to said continuous web.

6. A pressure sensitive intermediate web assembly as recited in claim 1, wherein said web is die cut to produce a plastic element selected from a group including cards, signs, placards, license plates, tags, tokens, chips and combinations thereof.

7. A pressure sensitive intermediate web assembly as recited in claim 1, including a supplemental element applied over said segments with said supplemental element selected from a group including labels, chips, tags and combinations thereof.

8. A pressure sensitive intermediate web assembly as recited in claim 1, wherein said printing on said segments includes graphical depictions having a resolution of greater than about 150 lines per inch.

9. A card intermediate assembly, comprising;
a plastic web of material having first and second faces, first and second transversely extending edges and first and second longitudinally extending sides, and said web having a substantially quadrate configuration;
a pattern of adhesive applied to said first face of said plastic web between said longitudinally extending sides and said transversely extending edges;
a sheet having a length and width and being divisible into a number of discrete individual segments, said sheet having printing applied in an area of each of said segments and each of said segments is smaller than said sheet after said segments are cut from said sheet; and
wherein at least one of said segments is cut from said sheet and applied to said plastic web over said pattern of adhesive and said segment is entirely contained between said longitudinally extending sides and said transversely extending edges to form a plastic card intermediate assembly.

10. A card intermediate assembly as recited in claim 9, including a first thermoplastic film that is applied over said segment to form a protective over laminate for said printing on said segment.

11. A card intermediate assembly as recited in claim 10, including a second thermoplastic film that is applied to said second face of said plastic web to create a protective laminate for said web.

12. A card intermediate assembly as recited in claim 9, wherein another preprinted segment is applied to said second face of said plastic web to create a plastic web assembly having preprinted segments on each face of said web.

13. A card intermediate assembly as recited in claim 9, wherein printing on said segments includes graphical depictions having a resolution of greater than about 150 lines per inch.

14. A card intermediate assembly as recited in claim 9, wherein said web has a thickness that is greater than each of said segments.

15. A laminated, plastic web assembly having a series of discrete, preprinted segments produced according to a method, comprising the steps of;
providing a continuous web of plastic material, said web having first and second faces and first and second longitudinally extending sides;
applying a pattern of adhesive to said first face of said web between said first and second longitudinally extending sides;
printing on a sheet of material;
cutting said sheet of material into a number of discrete individual segments that are smaller than said sheet, with each of said segments containing printing;
applying each of said segments sequentially to said continuous web of plastic material and over said pattern of pressure sensitive adhesive to create a continuous web having intermittently laminated preprinted segments applied thereto; and
laminating a synthetic film over each of said segments to create a laminated intermediate.

16. A laminated, plastic web assembly as recited in claim 15, including an additional step of verifying placement of each of said segments on said continuous web after the step of applying each of said segments to said web.

17. A laminated, plastic web assembly as recited in claim 15, including an additional step of applying a second synthetic film to said second face of said continuous web.

18. A laminated, plastic web assembly as recited in claim 15, including an additional step of applying a preprinted segment to said second face of said continuous web.

19. A laminated, plastic web assembly as recited in claim 18, wherein each of said segments applied to said first and second faces of said continuous web have related personalized indicia.

20. A laminated, plastic web assembly as recited in claim 15, including an additional step of placing an additional element over said segment after the step of applying said segment.
